(19) United States
(12) Patent Application Publication
(10) Pub. No.: US 2013/0032457 A1
(43) Pub. Date: Feb. 7, 2013

(54) PUSHBUTTON SWITCH

(71) Applicant: Ian Winston Quinn, Concord, MA (US)

(72) Inventor: Ian Winston Quinn, Concord, MA (US)

(73) Assignee: COACTIVE TECHNOLOGIES, LLC., Newton, MA (US)

(21) Appl. No.: 13/198,903

(22) Filed: Aug. 5, 2011

(51) Int. Cl. H01H 13/14

(52) U.S. Cl. 200/341

(57) ABSTRACT

A pushbutton switch configured to switch a mains voltage or line voltage while providing a tactile feedback to a user. The pushbutton switch includes a base having a plurality of fixed contacts, a movable contact having a plurality of contact points fitted within the base and configured to move from an open position to a closed position, a resilient actuator configured to receive and transfer a first pressure to the movable contact and shaped to provide a tactile feedback in response to the first pressure, and a retaining structure secured to the base and comprising a through-hole through which at least a portion of the actuator protrudes. In the pushbutton switch, conducting components on the movable contact and the plurality of fixed contacts are spaced apart such that the pushbutton switch is configured and rated to switch a line voltage.

### BACKGROUND

The present disclosure relates to a pushbutton switch. More specifically, the present disclosure relates to a pushbutton switch configured to function as a mains voltage or line voltage switch.

Pushbutton switches generally fall into one of two categories: (1) a line voltage power switch designed to switch line voltages and (2) a signal level switch.

Conventional line voltage pushbutton switches have several drawbacks. A line voltage switch is typically larger in size as a result of being configured to carry higher voltages (e.g., mains voltage or line voltage). As a result of the larger size, line voltage switches are typically not designed for use in a surface mount technology (SMT) assembly process with pick and place equipment (e.g., manufacturing or assembly equipment configured to automatically pick up a component and place the component on a printed circuit board or other similar device). Additionally, a line voltage switch generally has a longer stroke that does not match the tactile feel of low voltage switches.

Conventional signal level pushbutton switches also have several disadvantages. When used as a line voltage switch, a pushbutton switch must be sized accordingly to handle the higher voltage levels associated with a mains voltage or line voltage. Typical pushbutton switches including an elastic dome to provide tactile feedback can provide a relatively simple, compact and inexpensive solution for low power applications. However, due to limitations associated with typical pushbutton switch construction, tactile pushbutton switches cannot be used in applications where mains voltage or line voltage is required. One reason for this is typical movable pills or conductors in a pushbutton switch do not provide a large enough gap between the movable conductor and the stationary contacts for line voltages. Similarly, the geometry of the contacts in a typical tactile pushbutton switch do not provide a practical way of incorporating a plurality of silver-alloy contact surfaces generally required for switching line voltage.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a pushbutton switch configured to switch a line voltage. The pushbutton switch includes a base having a plurality of fixed contacts; a movable contact having a plurality of contact points fitted within the base and configured to move from an open position to a closed position, wherein conducting components on the movable contact and the plurality of fixed contacts are spaced apart such that the movable contact and the plurality of fixed contacts are configured to switch a line voltage; a resilient actuator configured to receive and transfer a first pressure to the movable contact, the resilient actuator shaped to provide a tactile feedback in response to the first pressure; and a retaining structure secured to the base and having a through-hole through which at least a portion of the actuator protrudes.

In another general respect, the embodiments disclose a pushbutton switch configured to switch a line voltage. The pushbutton switch includes a base having a plurality of fixed contacts; a movable contact having a plurality of contact points, the movable contact fitted within the base and configured to move from an open position to a closed position and establish a connection such that a line voltage is transferred through at least a portion of the movable contact from a first of the plurality of fixed contacts to a second of the plurality of fixed contacts; a resilient actuator having an upwardly protruding, substantially dome shaped pushbutton surface for receiving a first pressure, the resilient actuator shaped to transfer the first pressure to the movable contact thereby facilitating movement of the movable contact and to provide a tactile feedback in response to the first pressure; and a retaining structure secured to the base and having a through-hole through which the pushbutton surface protrudes.

### BRIEF DESCRIPTION OF THE DRAWINGS

FIG. 1 illustrates a pushbutton switch according to an embodiment.

FIG. 2 illustrates a cross-sectional view of the pushbutton switch of FIG. 1.

FIG. 3 illustrates an exploded view of the pushbutton switch of FIG. 1.

### DETAILED DESCRIPTION

The present disclosure relates to an improved pushbutton switch for switching mains voltage or line voltage while providing a tactile feel. The improved pushbutton switch operates like a typical pushbutton switch including an elastic actuator. However, the improved pushbutton switch as discussed herein replaces the typical conductive pill with a movable plate including a plurality of contact points spaced far enough apart to allow the contact points to provide safe switching at line voltage.

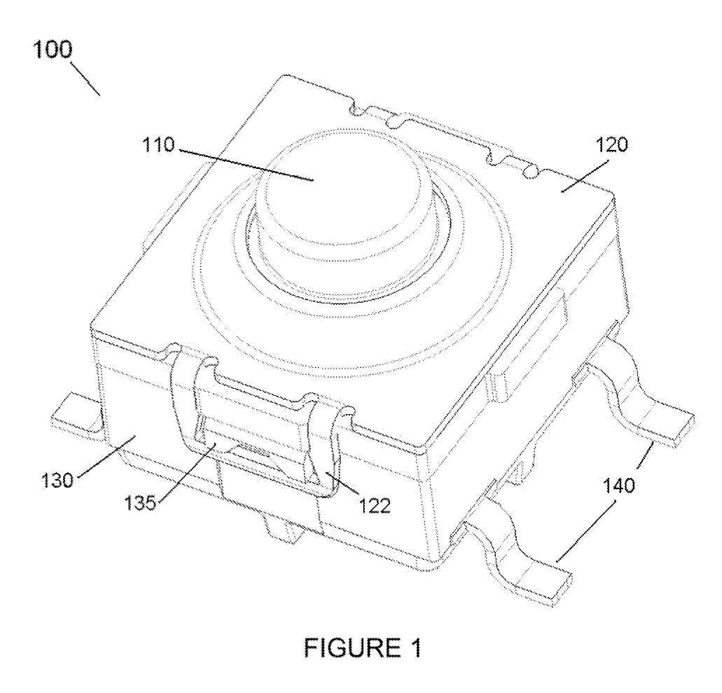

FIG. 1 illustrates an exemplary pushbutton switch 100 configured to provide a tactile feel and to operate as a signal line level switch at a typical line voltage, e.g., a voltage ranging from 110 VAC to 250 VAC, such as 110 VAC, 120 VAC, 240 VAC or 250 VAC. By using techniques and designs common to existing tactile pushbutton switches, the pushbutton switch 100 may be a relatively small size and shape for use in SMT assembly techniques.

The pushbutton switch 100 may include various components such as an actuator 110 made of a resilient or elastic material such as rubber or a soft plastic, a cover or retaining structure 120, a base 130 and two or more fixed contacts 140. It should be noted that the pushbutton switch 100 includes four fixed contacts (not all shown in FIG. 1) by way of example only. The actuator 110 is sized and shaped such that, when pushed, the actuator feels like a typical tactile pushbutton switch, providing a tactile feedback to a user when the user pushes or otherwise activates the pushbutton switch 100. A tactile feedback may be a result of a drop-off in reactive or resistant force, suggesting to the user the switch has closed or a triggering has occurred.

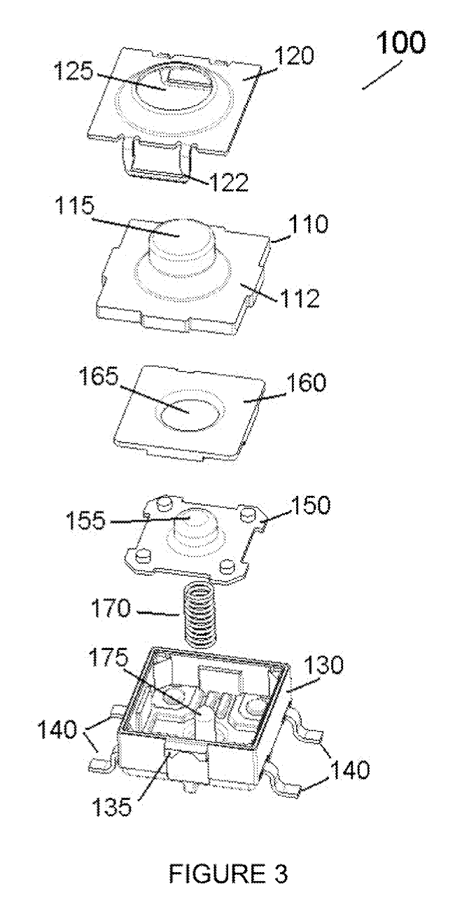

The actuator 110 may be shaped as a generally planar surface (i.e., surface 112 as shown in FIG. 3) having an upwardly protruding pushbutton surface (i.e., surface 115 as shown in FIG. 3). Similarly, the retaining structure 120 retains the actuator 110 in place and may include an opening sized and shaped such that the upwardly protruding pushbutton surface passes through the retaining structure for engagement with an operator's finger or similar pushing mechanism (i.e., through-hole 125 as shown in FIG. 3). The pushbutton surface of the actuator may be smaller in diameter than the opening of the retaining structure 120 such that the pushbutton protrudes through the opening while the generally planar surface of the actuator 110 fits under the retaining structure. It should be noted that the shape of actuator 110 as shown herein is by way of example only. Alternative shapes may be used for the actuator 110 depending on the size, configuration and application of the pushbutton switch 100.

The retaining structure 120 may include a clip (i.e., clip 122 as discussed below) that securely fastens the retaining structure to a housing or the base 130 of the pushbutton switch 100, thereby providing a lid for the base. The retaining structure 120 may also be sized and shaped such that the actuator 110 and other components of the pushbutton switch 100 are secured within or to the base 130. The retaining structure 120 may be made from a rigid material such as plastic or metal. The base 130 may be made from a non-conductive material such as plastic. The base 130 may include two or more external latching features or protrusions 135 to which individual loops or clips 122 of retaining structure 120 may affix, thereby securing the retaining structure to the base.

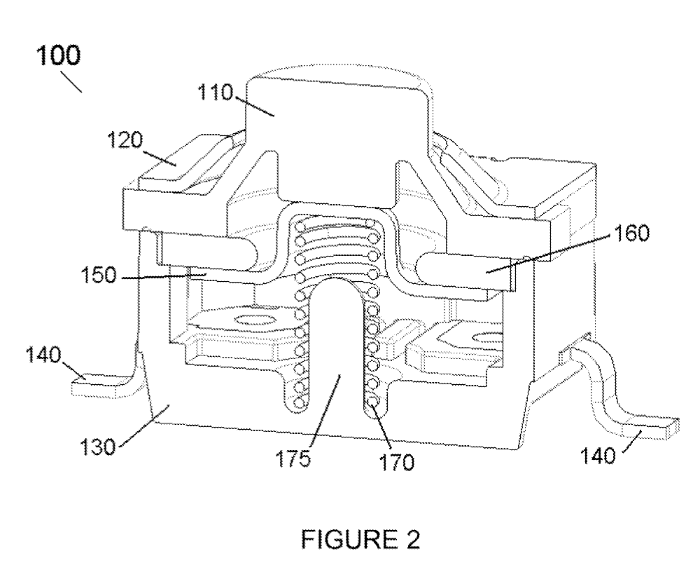

As shown in FIG. 2, the actuator 110 may be supported by a center plate 160. The center plate 160 may be a circular spacer such as a washer made from plastic or a similar non-conductive material. The actuator 110 may abut a movable contact 150. The movable contact 150 may be made entirely from a conductive material such as copper, silver, or other similar conductive materials. Alternatively, the movable contact may include a conductive outer ring and a non-conductive inner section. The movable contact 150 may include separate contact points or buttons attached to the movable contact and positioned such that the buttons strike the fixed contacts 140 upon movement of the movable contact. Alternatively, the movable contact 150 may include a formed conductive portion. The movable contact 150 may further include inlaid or plated components positioned such that the inlaid or fixed components protect the formed conductive portion. The inlaid or fixed components may be made from a material suitable for high current switching such as silver.

When depressed, movement of the actuator 110 may translate to movement of the movable contact 150 such that the movable contact, or the conductive portion of the movable contact, strikes the fixed contacts 140, momentarily completing one or more circuits. As such, the fixed contacts 140 are made from a conductive material such as copper, silver, or another similar conductive material. The spacer or center plate 160 may be positioned such that the center plate provides support for the actuator 110. Depending on the design of the actuator 110, the center plate 160 may support the upwardly protruding surface of the actuator such that the actuator provides a tactile feel when depressed. The center plate 160 may further define an upper limit stop for the movable contact 150, thereby improving a free position tolerance between the movable contact and other components of the pushbutton switch 100. Once assembled, the center plate 160 may be pressed against a stop in the base 130 by the actuator 110.

A resilient body such as spring 170 may be included to return the movable contact 150 to its original, open position. As pressure is applied to the actuator 110, the spring 170 may deform. Once pressure is removed from the actuator 110, the spring 170 may return to its normal shape and size, thereby causing the movable contact 150 to return to its original position away from the fixed contacts 140.

The base 130 may include a post 175 or other location feature for holding spring 170 in position. The spring may be positioned such that it passes through an opening in the center plate (i.e., through-hole 165 as shown in FIG. 3). An upwardly protruding component of the movable contact 150 (i.e., component 155 as shown in FIG. 3) may be cylindrically shaped to receive the spring 170. It should be noted that spring 170 is shown as a coil spring for exemplary purposes only. The pushbutton switch 100 may include alternative resilient bodies such as a leaf spring or an elastomer.

In another exemplary embodiment, actuator 110 may be connected to the movable contact 150. In this case, the elastic properties of the actuator 110 may provide a return force for the movable contact 150.

FIG. 3 illustrates an exploded view of the pushbutton switch 100. As shown in FIG. 3, the actuator 110 includes a generally planar surface having an upwardly protruding pushbutton surface 115. The movable contact 150 may be similarly shaped, having a generally planar surface and an upwardly protruding component 155 sized and configured to fit within the upwardly protruding pushbutton surface 115 of the actuator 110 as well as to receive at least a portion of the spring 170. Thus, when a downward pressure is applied to the pushbutton surface 115, the pressure is transferred to the upwardly protruding component 155 of the movable contact 150 and acts to downwardly deform the spring 175.

To accommodate the upwardly protruding pushbutton surface 115 and the upwardly protruding component 155, the retaining structure 120 may include a through-hole 125. The through-hole 125 may also provide a pathway for the application of downward pressure on the actuator 110 to transfer to the movable contact 150.

Similarly, the center plate 160 may include a through-hole 165 to accommodate the upwardly protruding component 155 of the movable contact 150. The through-hole 165 may also provide a pathway for the application of downward pressure on the actuator 110 to transfer to the movable contact 150 and thus to the fixed contacts 140.

By providing appropriate spacing and material use, the pushbutton switch as discussed above may be used as a mains voltage or line voltage switch. The base may be sized, shaped and configured to be mounted on a printed circuit board. An exemplary base may be manufactured to be 1 cm wide, 1 cm deep, and about 0.75 cm tall. These dimensions provide any necessary creepage (i.e., the space between conducting components over the insulator surface) and clearance requirements (i.e., the space between conducting components through the air) per international rating as required for 250 VAC operations while maintaining a package size smaller than typical line voltage switch. As a result of the design of the pushbutton switch, the switch provides a tactile feel, packaging size and processing options common to low-voltage switches while operating as a high voltage signal level switch.

Additionally, due to the compact size and shape of the pushbutton switch, the switch may be incorporated into various systems and devices via an SMT manufacturing process. For example, a pick and place machine may select a pushbutton switch, place the switch onto a printed circuit board, and the switch may be soldered or otherwise affixed to the printed circuit board. Additionally, the switch may be produced for a through hole manufacturing process.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A pushbutton switch configured to switch a line voltage, the pushbutton switch comprising:
a base comprising a plurality of fixed contacts;
a movable contact comprising a plurality of contact points fitted within the base and configured to move from an open position to a closed position, wherein conducting components on the movable contact and the plurality of fixed contacts are spaced apart such that the movable contact and the plurality of fixed contacts are configured to switch a line voltage;
a resilient actuator configured to receive and transfer a first pressure to the movable contact, the resilient actuator shaped to provide a tactile feedback in response to the first pressure; and
a retaining structure secured to the base and comprising a through-hole through which at least a portion of the actuator protrudes.

2. The pushbutton switch of claim 1, further comprising:
a center plate positioned to provide support for the actuator and an upper stop for the movable contact.

3. The pushbutton switch of claim 1, wherein the resilient actuator is substantially dome shaped.

4. The pushbutton switch of claim 1, further comprising:
a resilient body in contact with the movable contact and configured to return the movable contact to the open position.

5. The pushbutton switch of claim 4, wherein the resilient body is a coil spring.

6. The pushbutton switch of claim 1, wherein the resilient actuator is further configured to provide a return force on the movable contact, thereby returning the movable contact to the open position.

7. The pushbutton switch of claim 1, wherein the switch is sized and configured to be mounted on a printed circuit board.

8. The pushbutton switch of claim 1, wherein the line voltage is from 100 VAC to 250 VAC.

9. The pushbutton of claim 1, wherein the resilient actuator is further configured to function as a seal for the pushbutton switch.

10. A pushbutton switch configured to switch a line voltage, the pushbutton switch comprising:
a base comprising a plurality of fixed contacts;
a movable contact comprising a plurality of contact points, the movable contact fitted within the base and configured to move from an open position to a closed position and establish a connection such that a line voltage is transferred through at least a portion of the movable contact from a first of the plurality of fixed contacts to a second of the plurality of fixed contacts;
a resilient actuator comprising an upwardly protruding, substantially dome shaped pushbutton surface for receiving a first pressure, the resilient actuator shaped to transfer the first pressure to the movable contact thereby facilitating movement of the movable contact and to provide a tactile feedback in response to the first pressure; and
a retaining structure secured to the base and comprising a through-hole through which the pushbutton surface protrudes.

11. The pushbutton switch of claim 10, further comprising:
a center plate positioned to provide support for the actuator and an upper stop for the movable contact.

12. The pushbutton switch of claim 10, further comprising:
a resilient body in contact with the movable contact and configured to return the movable contact to the open position.

13. The pushbutton switch of claim 12, wherein the resilient body is a coil spring.

14. The pushbutton switch of claim 10, wherein the resilient actuator is further configured to provide a return force on the movable contact, thereby returning the movable contact to the open position.

15. The pushbutton switch of claim 10, wherein the switch is configured to be mounted on a printed circuit board.

16. The pushbutton switch of claim 10, wherein the line voltage is from 100 VAC to 250 VAC.

17. The pushbutton switch of claim 10, wherein the resilient actuator is further configured to function as a seal for the pushbutton switch.
